(19) United States
(12) Patent Application Publication
(10) Pub. No.: US 2006/0061682 A1
(43) Pub. Date: Mar. 23, 2006

(54) User selectable content stream

(76) Inventors: Bruce R. Bradley, North Wales, PA (US); Mark Hess, Haverford, PA (US); Alexander Hess, Haverford, PA (US)

Correspondence Address: PATTERSON & SHERIDAN, LLP/;SEDNA PATENT SERVICES, LLC, 595 SHREWSBURY AVENUE, SUITE 100, SHREWSBURY, NJ, 07702, US

(21) Appl. No.: 10/946,682

(22) Filed: Sep. 22, 2004

(51) Int. Cl. H04N 11/20; H04N 7/01; H04N 7/16

(52) U.S. Cl. 348/441; 725/135; 348/448

(57) ABSTRACT

A method for enabling user selection of an alternate format simulcast programming.

### BACKGROUND OF THE INVENTION

1. Field of the Invention

The invention relates to communication systems in general and, more specifically, the invention relates to user selection of a simulcast content stream having different formats.

2. Description of the Background Art

Within the context of digital television systems such as satellite television, digital cable television and the like, it is known to provide content at a standard definition (SD) format on a first channel and a high definition (HD) format on a second channel. However, unless the user checks with an electronic program guide (EPG), the user will not know that an alternate format version of the presently viewed content is available.

Typically, the standard definition content is displayed at a 4:3 aspect ratio, while the high definition content is displayed at a 16:9 aspect ratio. Where the aspect ratio of the received and displayed content corresponds to the aspect ratio of a viewer's display device (i.e., television) the displayed image is satisfactory. Where the aspect ratio of the content does not match the aspect ratio of the display device, the displayed content must be modified in some way to fit. For example, HDTV content when displayed on a 4:3 aspect ratio display device is typically displayed in a letter box format, while SDTV content displayed on a 16:9 aspect ratio display device is typically displayed in a pillar box format. Other modifications include stretching, cropping and the like. Such adaptations based on aspect ratio and the like are often objectionable to the user

### SUMMARY OF INVENTION

The above deficiencies in the prior art are addressed by a method enabling user selection of available content having a desired format. Specifically, a method according to one embodiment of the invention comprises: generating a presentation signal in response to a first selected channel, the presentation signal being adapted to present content from the first selected channel according to a first format, the presentation signal including imagery indicative of the content also being available in a second format; and in response to a control signal, generating the presentation signal in response to a second channel, the presentation signal being adapted to present the content from the second channel according to the second format.

### BRIEF DESCRIPTION OF THE DRAWINGS

The teachings of the present invention can be readily understood by considering the following detailed description in conjunction with the accompanying drawings, in which:

FIG. 1 depicts a displayed image according to an embodiment of the present invention;

FIG. 2 depicts a high level block diagram of an information receiver according to an embodiment of the invention;

FIG. 3 depicts a flow diagram of a method according to an embodiment of the present invention; and

FIG. 4 depicts an exemplary image frame according to an embodiment of the invention.

To facilitate understanding, identical reference numerals have been used, where possible, to designate identical elements that are common to the figures.

### DETAILED DESCRIPTION OF THE INVENTION

The invention will be primarily described within the context of a set top terminal (STT) in a customer premises within a digital cable television system. It will be appreciated by those skilled in the art that the invention may also be practiced within the context of any information distribution system, such as a satellite system, video over internet protocol system and the like. Further, it will be appreciated by those skilled in the art that the STT functionality described herein is equally applicable to a stand-alone STT or an STT function included within a presentation device such as a television or other display/audiovisual device. Moreover, the invention may be implemented within the context of a computing device operating in the manner described herein with respect to the various embodiments of the invention.

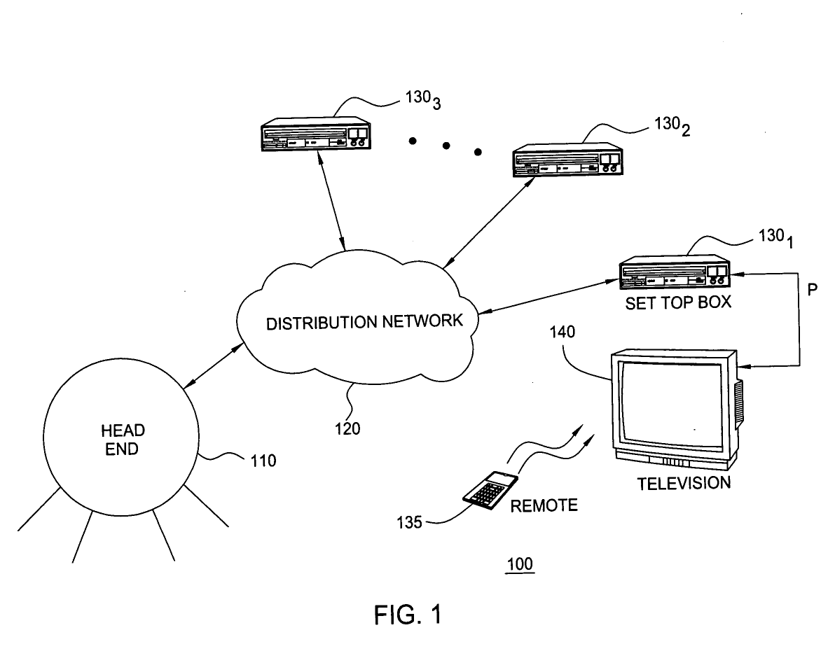

FIG. 1 depicts a high level block diagram of an information distribution system suitable for use with the present invention. The system 100 of FIG. 1 comprises, illustratively, a cable television or satellite television distribution system.

The system 100 of FIG. 1 comprises a head end 100 operatively coupled to at least one distribution network 120. The distribution network 120 communicates with a plurality of set top terminals (STTs) 130₁, 130₂, and so on up to 130_{N} (collectively set top terminals 130). Each set top terminal 130 communicates with at least one respective presentation device such as a television 140 or other display device. Each set top terminal 130 is typically associated with a remote control device 135 or front panel keypad to enable user input. The presentation device 140 receives a presentation signal such as a digital video signal, analog video signal, packetized audiovisual stream (e.g., MPEG stream) and the like.

The set top terminals 130 may comprise stand alone set top terminals or circuitry within the presentation device 140 that performs the set top terminal functionality described herein. Moreover, the set top terminal 130 may also comprise a computer or other data processing device programmed and/or configured to perform the set top terminal functionality described herein. In this instance, the presentation device 140 may comprise a computer monitor or other computer display device. The presentation signal P may comprise any digital or analog signal suitable for conveying audiovisual information to a display device. The format of the presentation signal may be an analog modulated format, a digital packetized format, a digital modulated format and the like. In one embodiment of the invention, the set top terminal 130 may comprise a computer including a modem such as a cable modem or digital subscriber line (DSL) modem communicating with a distribution network 120 such as the internet.

The head end 110 operates to provide content via a plurality of channels through the distribution network 120 to the set top terminals 130. A forward application transport channel (FATC) is used to provide a high bandwidth channel suitable for use in delivering, for example, video and other audiovisual programming. The forward application transport channel or a forward data channel (FDC) is used to propagate control information from the head end 110 to the set top terminals 130. A back channel (BC) is optionally used to propagate commands and other selections from the set top terminals 130 to the head end 110 via the distribution network 120 or an alternative distribution network (not shown).

The FATC is configured to provide a plurality of channels, where each channel provides the video and audio streams necessary to produce, at a set top terminal or other information receiver, an audiovisual program. For purposes of this discussion, it is assumed that some of the channels within the FATC deliver SDTV programming, some of the channels within the FATC deliver HDTV programming, and some of those SDTV and HDTV channels are simulcasting the same program in their respective SDTV and HDTV format. The actual channel used to provide a specific program is identified, for example, by information within an electronic program guide EPG. Thus, in one embodiment of the invention, channel mapping information used to identify simultaneously broadcast SDTV/HDTV programming is provided to an EPG data base at an STT. In other embodiments, a virtual channel map may be constructed using the Protocol for System Information and Program guide (PSIP) functionality described within the various Moving Pictures Expert Group (MPEG) standards and related standards. In this system, virtual channels are generated using PSIP tables, program association tables (PATs) and program map tables (PMT). These tables support information which may be used to associate virtual channels carrying simulcast SDTV and HDTV programming. Other methods and techniques for associating simultaneously broadcast content may also be used and are considered by the inventors to be applicable within the context of the present invention.

One embodiment of the invention is implemented as a program product for use with a computer system such as, for example, the set top terminal processing system 200 and described below. The program(s) of the program product defines functions of the invention embodiments and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines and methods executed to implement the embodiments of the invention, whether implemented as part of an operating system or a specific application, applet, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

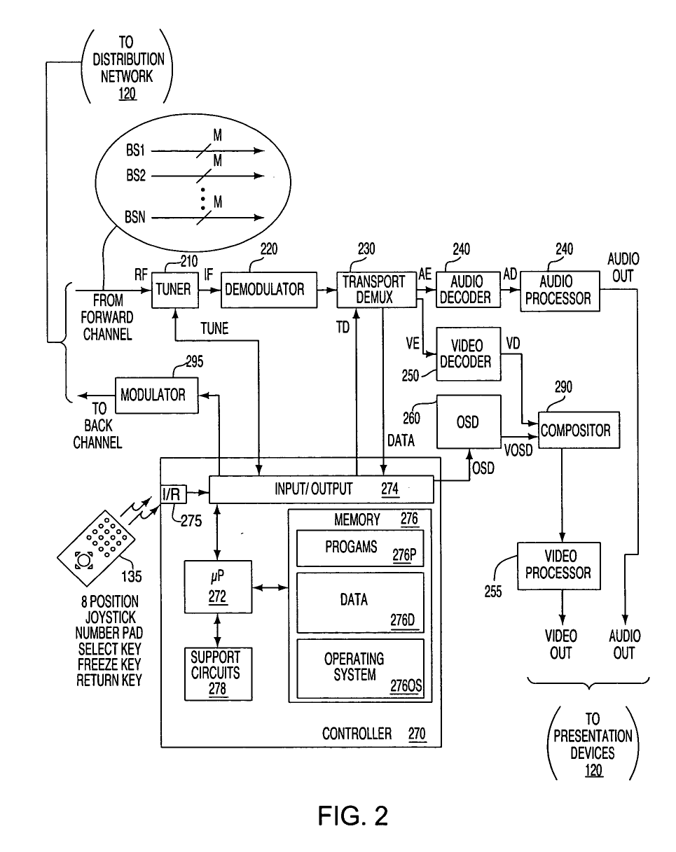

FIG. 2 depicts a block diagram of an STT 200 suitable for use in accordance with the present invention, such as STT 130 of the system 100 of FIG. 1. The STT 200 comprises a tuner 210, a demodulator 220, a transport demultiplexer 230, an audio decoder 240, an audio processor 245, a video decoder 250, a video processor 255, an on-screen display processor (OSD) 260, a video compositor 290 and a controller 270. User interaction is provided via a remote control unit 135.

Tuner 210 receives, e.g., a radio frequency (RF) signal comprising, for example, a plurality of quadrature amplitude modulated (QAM) information signals from a downstream (forward) channel. Tuner 210, in response to a control signal TUNE, tunes a particular one of the QAM information signals to produce an intermediate frequency (IF) information signal. Demodulator 220 receives and demodulates the intermediate frequency QAM information signal to produce an information stream, illustratively an MPEG transport stream. The MPEG transport stream is coupled to a transport stream demultiplexer 230.

Transport stream demultiplexer 230, in response to a control signal TD produced by controller 270, demultiplexes (i.e., extracts) an audio information stream A and a video information stream V.

The audio information stream A is coupled to audio decoder 240, which decodes the audio information stream and presents the decoded audio information stream to the audio processor 245. The audio processor 245 adapts the audio stream to produce an audio output signal suitable for use by a presentation device, such as presentation device 140.

The video information stream V is coupled to the video decoder 250, which decodes the video information stream V to produce an uncompressed video stream VD that is coupled to the video compositor 290. OSD 260, in response to a control signal OSD produced by controller 270, produces a graphical overlay signal VOSD that is coupled to the video compositor 290. The graphical overlay may comprise, for example, an indicator for identifying a presently viewed program as having a simulcast alternative format version available on another channel. The video compositor 290 merges the graphical overlay signal VOSD and the uncompressed video stream VD to produce a modified video stream (i.e., the underlying video images with the graphical overlay) that is coupled to the video processor 255. The video processor 255 processes the signal supplied by the compositor 290 to produce a video signal suitable for use by a presentation device, such as presentation device 140.

Controller 270 comprises a microprocessor 272, an input/output module 274, a memory 276, an infrared (IR) receiver 275 and support circuitry 278. The microprocessor 272 cooperates with conventional support circuitry 278 such as power supplies, clock circuits, cache memory and the like as well as circuits that assist in executing the software routines that are stored in memory 276. The controller 270 also contains input/output circuitry 274 that forms an interface between the controller 270 and the tuner 210, the transport demultiplexer 230, the onscreen display unit 260, the back channel modulator 295, and the remote control unit 280. Although the controller 270 is depicted as a general purpose computer that is programmed to perform specific control functions in accordance with the present invention, the invention can be implemented in hardware as an application specific integrated circuit (ASIC). As such, the process steps described herein are intended to be broadly interpreted as being equivalently performed by software, hardware, or a combination thereof. The controller 270 optionally propagates command and/or controller information to the head end by modulating the command and/or control information using the modulator 295 and propagating the modulated information to the head end via the back channel BC.

In the exemplary embodiment of FIG. 2, the remote control unit 280 comprises a joy stick, a numeric pad, a “select” key and the like. User manipulations of the joy stick or keys of the remote control device are transmitted to a controller via an infra red (IR) link. The controller 270 is responsive to such user manipulations and executes appropriate user interaction routines.

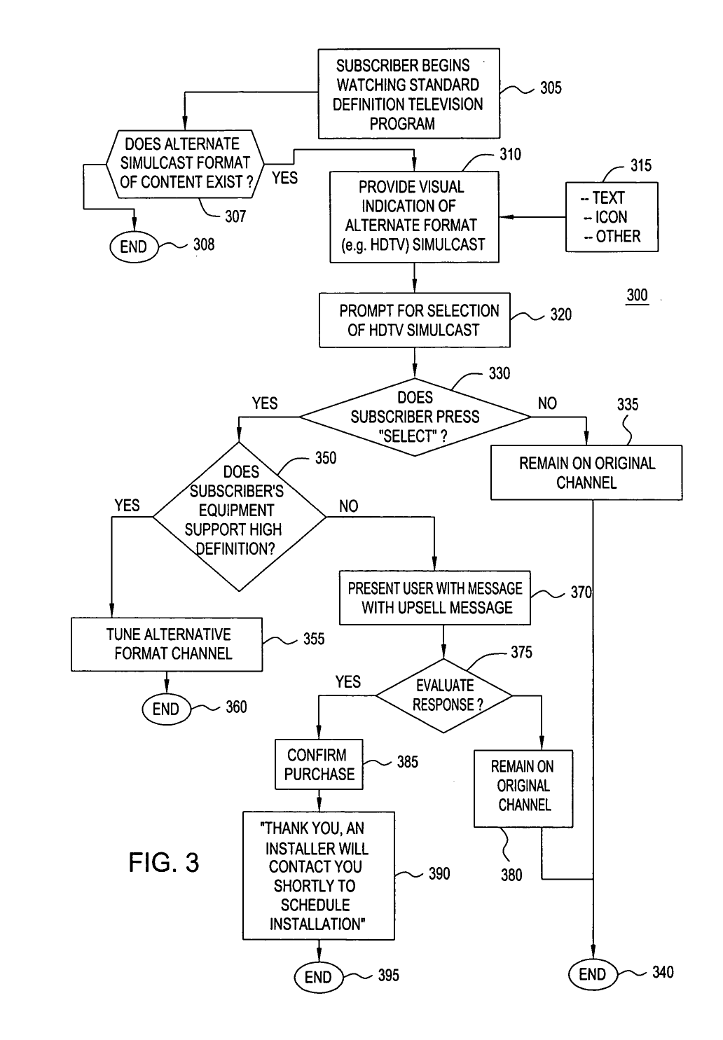

The memory 276 of controller 270 includes storage space for programs 276P, data 276D and an operating system 276OS. Within the context of the present invention, the programs 276P include programs which, when executed, perform methods according to the present invention, such as described below with respect to FIG. 3. The data 276D includes data tables and/or channel maps including data provided by the head end as part of an interactive program guide data base or other data base. The channel mapping is used to identify channels which are simulcasting content in alternate formats. That is, the data base may be used to store channel pairing information such that the presence or absence of a simulcast channel is noted for purposes of user indication and, in the event of user selection of the simulcast channel, the appropriate simulcast channel may be selected via the tuner 210 and/or transport demux 230. It will be appreciated by those skilled in the art and informed by the teachings of the present invention that more than two channels may be used to simulcast content. For example, multiple channels or virtual channels may be used to provide content in a variety of formats, a variety of languages and the like.

In one embodiment of the invention, in response to activation of the “select” key (or some other user input) the presently selected channel is deselected and the simulcast channel is selected for display. That is, activation of this user input operates to toggle between the two (or more) simulcast channels.

FIG. 3 depicts a flow diagram of a method according to an embodiment of the present invention. Specifically, the method 300 of FIG. 3 is adapted to operate within a set top terminal such as described above with respect to FIG. 2. The method operates to provide user controlled selection of alternatively formatted content corresponding to presently displayed content.

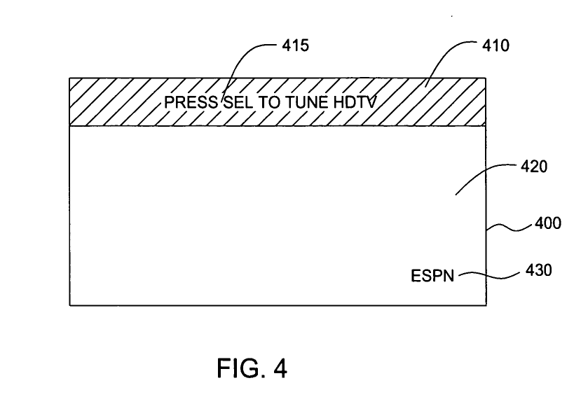

The method 300 of FIG. 3 is entered at step 305, when a subscriber begins watching television program of a first format, illustratively a standard definition television (SDTV) program. At step 307, a determination is made as to whether an alternate simulcast format of the television program being viewed exists on another channel. If there is no alternate simulcast format of the presently viewed content, then the method exits at step 308. Otherwise, at step 310 a visual indication of the existence of the alternate format simulcast is provided. Referring to box 315 (and FIG. 4), the visual indication may comprise a textual indication, a graphical indication such as an icon or some other indication. At step 320, the viewer is prompted for selection of the alternate format simulcast program or content, illustratively an HDTV simulcast of a presently viewed SDTV program.

At step 330, a determination is made as to whether the subscriber has pressed a “SELECT” or other key indicative of a desire to select the alternative format simulcast program. Step 330 may be invoked after a predetermined delay (e.g., several seconds after the prompt of step 320 is displayed) or in response to an actual key activation. If the subscriber does not select the alternate format simulcast, then at step 335 the set top terminal remains tuned to the original channel and the method 300 is exited at step 340. Otherwise, at step 350 a determination is made as to whether the subscriber's set top terminal supports the alternative format (e.g., HDTV) of the simulcast program. If the STT supports the high definition or other alternative format, then at step 355 the STT is tuned to the channel supporting the alternative format simulcast program. The method is then exited at step 360.

If at step 350 a determination is made that the subscriber equipment does not support the alternative format (e.g. high definition), then at step 370 the viewer is presented with a sales message, such as a text message stating “would you like to subscriber to high definition service?” At step 375, the user response is evaluated. If the sales message is declined, then at step 380 the STT remains tuned to the original channel and the method exits at step 340. If the sales message is accepted, then at step 385 the sale is confirmed by, for example, the user pressing an additional key. At step 390, a message indicating that the user will be contacted shortly by an installer (in the case of a need for new equipment) is displayed, and the method exits at step 395.

The above-described method is described primarily within the context of a user viewing an SDTV program and, if an HDTV simulcast exists, enabling the user to select such a simulcast program. It will also be appreciated that a user may be watching an HDTV program and choose to select an SDTV simulcast of that program. For example, where an HDTV program is viewed by the user on a 4:3 aspect ratio display device (e.g., in a letter box format), the user may desire to view the SDTV equivalent of that program to utilize the full screen area of the display device. The method provides direct user selection of simulcast alternative format programs, thereby enabling increased user control of the viewing process and providing increased satisfaction to the user.

In an alternate embodiment of the invention, a user may at any time (with or without a prompting message) selectively tune and present simulcast alternative format programming by pressing a single key on a remote control device. The STT, upon noting the selection of such a key, first determines whether a simulcast alternative format program exists. If such a program exists, then the new channel is tuned. Optionally, the sales message is displayed where the subscriber's STT does not support the alternative format. The selected signal for tuning the simulcast alternative format program channel may be provided by a remote control device or a control panel on the STT.

It is noted that various alternative formats may comprise 480 line interlaced (480I), 480 line progressive (480P), 720P, 1080P and the like. Other alternative formats may comprise MPEG-2, MPEG-4 and other compression formats. Other modifications may comprise varying frame rates or other video image characteristics.

FIG. 4 depicts an exemplary image frame according to an embodiment of the invention. Specifically, FIG. 4 depicts an image frame 400 such as displayed upon a television or other display device comprising content imagery 420 including a channel indicator or logo 430. Also depicted in FIG. 4 is a graphical overlay 410 including a text message (shown) or a graphical icon (not shown) 415. The text message 415 depicted in FIG. 4 states “PRESS SEL TO TUNE HDTV.” The SEL key or “SELECT” key refers to a button or key on a user remote control device 135 (or STT keypad) which, when activated, is interpreted by the STT as a user command to select an alternative format simulcast channel of the presently viewed channel, such as a high definition television (HDTV) channel corresponding to the presently selected standard definition television (SDTV) channel.

The overlay 410 with text or graphical icon 415 is only displayed when the content 420 is available in an alternate format via another channel. In the example of FIG. 4, the content 420 is displayed as standard definition television (SDTV) content on the presently tuned channel, while corresponding content is also available as high definition television (HDTV) content via an alternate channel. The graphical overlay 410 and associated text or graphical icon 415 is displayed to indicate to the user that the content on the corresponding HDTV channel is available. Similarly, if the content 420 is presently tuned via an HDTV channel, the graphical overlay 410 will include text or a graphical icon indicating that an SDTV channel may be tuned by activating the SELECT button. It will be appreciated that the actual mode of selecting the alternate channel may comprise a select button or any other means. Alternatively, rather than pressing a specific button, the actual channel number of the corresponding channel may be displayed such that the user may enter the channel number directly via, for example, a remote control device.

In one embodiment, the invention comprises an apparatus including signal processing circuitry adapted to selecting a first one of a plurality of content bearing channels received via a distribution network and producing therefrom an audiovisual signal representing the content. The audiovisual signal further includes imagery indicative of the content also being available in an alternate format via a second one of said plurality of content bearing channels. The signal processing circuitry, in response to a control signal such as a user select command, operates to select the second one of said plurality of content bearing channels such that the audiovisual signal represents the content as provided by the second channel and includes imagery indicative of the content also being available in an alternate format via the first channel (or some other channel/format). The apparatus may be implemented as a set top terminal or display device (e.g., television) having such a set top terminal function. The audiovisual signal is adapted to the presentation circuitry (i.e., video and/or audio circuitry) within a display device. The apparatus includes circuit components such as those described above with respect to the various Figures.

While the foregoing is directed to the preferred embodiment of the present invention, other and further embodiments of the invention may be devised without departing from the basic scope thereof, and the scope thereof is determined by the claims that follow.

What is claimed is:

1. A method, comprising:
generating a presentation signal in response to a first selected channel, said presentation signal being adapted to present content from said first selected channel according to a first format, said presentation signal including imagery indicative of said content also being available in a second format; and
in response to a control signal, generating said presentation signal in response to a second channel, said presentation signal being adapted to present said content from said second channel according to said second format.

2. The method of claim 1, wherein said first format comprises a high definition television (HDTV) format and said second format comprises a standard definition television (SDTV) format.

3. The method of claim 1, wherein said first format comprises a standard definition television (SDTV) format and said second format comprises a high definition television (HDTV) format.

4. The method of claim 1, wherein said first and second formats comprises respective formats from the group consisting of 480I, 480P, 720P and 1080P formats.

5. The method of claim 1, wherein:
in the case of said content not being available in said second format, said response to said control signal comprises generating said presentation signal in response to said first channel.

6. The method of claim 1, wherein said control signal comprises a user input signal.

7. The method of claim 6, wherein said user input signal comprises a “select” signal generated by manipulation of at least one of a set top terminal (STT) control panel and a remote control device.

8. The method of claim 1, wherein said imagery indicative of said content also being available in a second format is provided as graphical imagery adapted to overlay video imagery associated with said content.

9. The method of claim 8, wherein said graphical imagery is included within said presentation signal for a predetermined amount of time.

10. The method of claim 8, wherein said graphical imagery and content video imagery are combined at a STT in response to said STT determining that said content is available in said second format on another channel.

11. The method of claim 8, wherein said graphical imagery and content video imagery are combined prior to being received at a STT.

12. The method of claim 1, further comprising:
identifying those channels providing corresponding content according to different formats to produce a corresponding channel map, wherein:
said second channel is selected according to said corresponding channel map.

13. The method of claim 12, wherein:
said control signal comprises a user input signal; and
said method further comprises alternatively adapting said presentation signal between said first channel and said second channel in response to said user input signal.

14. A signal bearing medium including a representation of software instructions which, when executed by a processor, perform a method comprising:
generating a presentation signal in response to a first selected channel, said presentation signal being adapted to present content from said first selected channel according to a first format, said presentation signal including imagery indicative of said content also being available in a second format; and
in response to a control signal, generating said presentation signal in response to a second channel, said presentation signal being adapted to present said content from said second channel according to said second format.

15. A computer program product, comprising a computer data signal embodied in a carrier wave having computer readable code embodied there in for causing a computer to perform a method comprising:
generating a presentation signal in response to a first selected channel, said presentation signal being adapted to present content from said first selected channel according to a first format, said presentation signal including imagery indicative of said content also being available in a second format; and
in response to a control signal, generating said presentation signal in response to a second channel, said presentation signal being adapted to present said content from said second channel according to said second format.

16. The computer program product of claim 15, wherein said computer comprises a processing element within a set top terminal.

17. The computer program product of claim 15, wherein said computer comprises a processing element within a presentation device.

18. Apparatus, comprising:
signal processing circuitry adapted to selecting a first one of a plurality of content bearing channels received via a distribution network and producing therefrom an audiovisual signal representing said content and including imagery indicative of said content also being available in an alternate format via a second one of said plurality of content bearing channels;
said signal processing circuitry, in response to a control signal, selecting said second one of said plurality of content bearing channels and producing therefrom an audiovisual signal representing said content and including imagery indicative of said content also being available in an alternate format via said first one of said plurality of content bearing channels.

19. The apparatus of claim 18, wherein said apparatus is adapted for use within a set top terminal.

20. The apparatus of claim 18, wherein said apparatus is adapted for use within a display device.
